(19) United States
(12) Patent Application Publication
(10) Pub. No.: US 2008/0166939 A1
(43) Pub. Date: Jul. 10, 2008

(54) Acoustical Substrate

(75) Inventors: Keith Black, Raleigh, NC (US); Michael L. Reynolds, Raleigh, NC (US)

Correspondence Address: FREUDENBERG NONWOVENS L. P., 3440 INDUSTRIAL DRIVE, DURHAM, NC, 27704, US

(73) Assignee: FREUDENBERG NONWOVENS L.P.

(21) Appl. No.: 11/621,418

(22) Filed: Jan. 9, 2007

(51) Int. Cl. B32B 5/02; B29C 65/02; B32B 37/04

(52) U.S. Cl. 442/150; 156/275.7

(57) ABSTRACT

The present disclosure provides an acoustical substrate including nonwoven material which includes a two component adhesive system which may be treated with a fluid repelling compound. The two component adhesive system may comprise two adhesive components having different melting points to allow for flexible industrial post processing and laminating. The adhesives may be applied by a variety of methods and may exist in the substrate in, e.g., either discrete or continuous web forms.

### FIELD OF THE INVENTION

This invention relates to a nonwoven material incorporating a plurality of adhesives which may have different softening temperatures. Such nonwoven material may serve as a substrate, and when coupled with other components capable of providing sound attenuation (e.g., high loft materials and or foams), and when including a fluid repellant, the resultant product may be particularly suited to automotive applications where water repellency and acoustical performance may be critical.

### BACKGROUND

Adhesive systems may be employed on nonwovens and textiles materials. For example, various polymer materials suitable to function as an adhesive may be applied to nonwoven materials on one or both sides of a non-woven substrate. Other filler materials may also be incorporated into the non-woven web.

Acoustical insulation materials have also been reported, which may be in the form of a nonwoven web containing relatively fine thermoplastic fibers. The diameter of the fibers and the thickness of the web may be adjusted to influence sound attenuation. In addition, the acoustical insulation materials may include layers of materials, such as a first layer of a nonwoven web followed by a second layer of relatively high loft material. In addition, foam or film layers may be selectively employed.

In addition, various compounds have been reported that may provide hydrophobic or water repellant characteristics. These may include relatively non-polar chemical compounds, which may include compounds or polymers that rely upon the presence of fluorine functionality or even silicon type functionality.

Acoustical properties are significant to mitigate and dampen the effect of sounds and vibrations. In particular, the automotive industry has long valued the incorporation of noise-reduction materials into interior vehicular components. Further, additional properties such as water repellency may also be required for applications including interior trim components (e.g. a door panel). As the complexity of vehicle sound attenuation systems increase, it may be necessary to develop materials which may provide a combination of properties within, e.g., a single laminated structure. This may then provide an opportunity for materials that may, for instance, attenuate sound, repel water and additionally provide the flexibility to be attached to different and otherwise incompatible materials and different laminating temperatures. The present invention may therefore provide solutions to one or a combination of these problems described above.

### SUMMARY OF THE INVENTION

In a first exemplary embodiment, the present disclosure relates to an acoustical substrate that includes a nonwoven web and a plurality of adhesives. For example, a first adhesive having a first melting temperature (Tm₁) and a second adhesive having a second melting temperature (Tm₂) wherein Tm₁ is not equal to Tm₂. A fluid repellant may dispersed in the non-woven web, such as a hydrophobic fluid to reduce water absorption.

In a second exemplary embodiment, the present disclosure relates to a process for forming an acoustical substrate the includes providing a first nonwoven material and applying a first adhesive having a first melting temperature (Tm₁) and a second adhesive having a second melting temperature (Tm₂) wherein Tm₁ is less than Tm₂. A fluid repellant may also be dispersed within the non-woven material. One may then laminate at a temperature above Tm₁ while maintaining the laminating temperature at a temperature below Tm₂. This may then be followed by providing a second sound attenuating component and laminating at a temperature above Tm₂.

### BRIEF DESCRIPTION OF THE DRAWINGS

FIG. 1 is a plan view of one exemplary embodiment of the present disclosure.

FIG. 2 is a sectional view of FIG. 1 taken along lines 2-2.

FIG. 3 is a plan view of another exemplary embodiment of the present disclosure wherein all or a portion of the second adhesive component has been removed from the surface of the nonwoven web.

FIG. 4 is a sectional view of FIG. 3 along lines 4-4.

FIG. 5 is a plan view of another exemplary embodiment of the present disclosure wherein the first adhesive is illustrated a continuous web and the second adhesive is illustrated as a discrete component.

FIG. 6 is a sectional view of FIG. 5 alone lines 6-6.

FIG. 7 is a plan view of another exemplary embodiment of the present disclosure including a continuous first adhesive web and a printed second adhesive component.

FIG. 8 is a sectional view of FIG. 7 along lines 7-7.

### DETAILED DESCRIPTION

The nonwoven material suitable for use herein may be what is commonly referred as a spunbond material. This may be understood as a nonwoven material which may be formed in which the filaments have been extruded, drawn and laid on a moving screen to form a web. The nonwoven material may also be sourced from a melt blowing process, wherein a nonwoven web may be formed by extruding and drawing molten polymer with heated, relatively high velocity air to form relatively fine filaments.

A spunbond/meltblown composite may also be employed and may therefore be understood as a multiple layer fabric that is generally made of various alternating layers of spunbond and melt blown webs. For example, the fabric may comprise the following layering: spunbond/melt-blown/spunbond (SMS); spunbond/meltblown/meltblown/spun bond (SMMS); spunbond/spunbond/melt blown/melt blown/spunbond (SSMMS).

In addition, the nonwoven material may comprise a continuous filament spunbond microfiber nonwoven. Such nonwoven material may be manufactured using a variety of fiber-polymer systems known to those skilled in the art. The SMS material may be formed from a thermoplastic polymer, e.g. polypropylene, polyethylene or polyethylene terephthalate or any combination thereof.

The continuous filament spunbond microfiber nonwoven may be a mono-component nonwoven or a multi-component nonwoven. Further, the continuous filament spunbond microfiber nonwoven may utilize a combination of mono-component filaments and multi-component filaments. Such multiple component filament structures may be, for instance, sheath core, islands in the sea, segmented-pie, tri-lobal, rectangular or segmented ribbon shapes or any combination thereof. Such multi-component fibers may be subject to splitting or fracture, or single component removal during subsequent processes to effectuate the creation of small fiber diameters dependent upon the method by which the nonwoven micro-fiber nonwoven may be created. These materials may be produced from polyethylene terephthalate (PET), polyamide-6, polyamide-6,6, polyethylene, polylactic acid, polypropylene or any combination thereof. Further, any such combination of the aforementioned polymer systems to effectuate a bi-component material for later fracture or splitting is contemplated to be an embodiment embraced under the scope of this invention.

Structurally, the nonwoven fiber diameters may generally be less than 100 μm, preferably less than about 50 μm, more preferably less than about 20 μm and most preferably less than about 15 μm. Accordingly, the nonwoven fiber diameters herein may include fiber diameters between 1-100 μm including all values and ranges therein. In addition, the basis weights of the nonwoven material may be less than or equal to about 400 g/m². The basis weight may also range from about 40-g/m² to about 400 g/m², including all values and ranges therein.

The nonwoven material herein may be further characterized by a measurement of its airflow resistance or acoustical impedence (Rayls). In MKS units, 1 Rayl equals 1 pascal-second per meter (Pa-s-m⁻¹). The nonwoven materials herein may therefore have a value of from about 200-2000 Rayls including all values and increments therein. For example, the nonwoven material may have a value of about 600-1800 Rayls, or about 800-1200 Rayls.

The sound absorption coefficient of the acoustical substrate when laminated to a relatively high loft nonwoven or foam component may also be evaluated. For example, when the nonwoven materials described above, including the adhesive systems described below, along with the fluid repellant, is laminated to a relatively high loft nonwoven (e.g. a lofty short staple, oven bonded nonwoven, with a thickness of about 14 mm and a basis weight of about 260 g/m²), the sound absorption coefficient may be greater than about 0.8 for frequencies greater than 1000 Hz. Further, the sound absorption coefficient may be greater than about 1.0 for frequencies between about 1250 and about 5000 Hz. The sound absorption coefficient may be obtained using an Alpha Cabin/APAMAT II testing device available from Rieter Corporation.

The adhesive system may comprise a plurality of components, such that each component may serve to provide a specific post-processing window for industrial processors to laminate the acoustical substrate to a wide array of components capable of providing sound attenuation, such as other polymeric materials, foams, nonwovens, etc. It has therefore been found advantageous to utilize at least two adhesives to accommodate specific post processing/laminating techniques. The specific combinations of adhesives may therefore allow downstream industrial laminating at two or more distinctly different temperature ranges. Accordingly, if several adhesives are employed, each may be selected to provide adhesion at a selected temperature or melting point depending upon the requirements of, e.g., a downstream laminating operation. In addition, the nonwoven web containing the adhesive system may itself be selectively heated at different and targeted locations so that only a portion or some selected area or areas of the web undergo thermal treatment and lamination to a given sound attenuating component. It may be appreciated that this then may further optimize the use of the adhesive system herein.

The disclosure will therefore be further described with respect to a two component adhesive system, however, it can be appreciated that multiple adhesive systems are contemplated, e.g. where the number of adhesives may include between 2-10 adhesives components, all with different melting temperatures. For example, the number of adhesive may be 3, 4, 5, 6, etc.

The adhesive system herein, regardless of how it may be applied (see below) may therefore include both a relatively low melting point (Tm) adhesive component and a relatively high melting adhesive component. The difference in melting temperature between the low-melting adhesive component and high-melting adhesive component may be at least 10° C. or more. More preferably, the difference between the low-melting adhesive component and high-melting adhesive component may be at least 20° C. Accordingly, it may be appreciated that the difference in melting points between the two adhesive components may be in the range of 10-50° C., including all values and ranges therein. Exemplary adhesive components may include polyesters, co-polyesters, polyamides and co-polyamides. Such adhesive components may therefore include Griltex® D1582E and Griltex® 6E manufactured by EMS Inc. Further, adhesive components sold by Arkema under the trade name Platamid® 8020 and Platamid® H106 PA 80 may also be utilized.

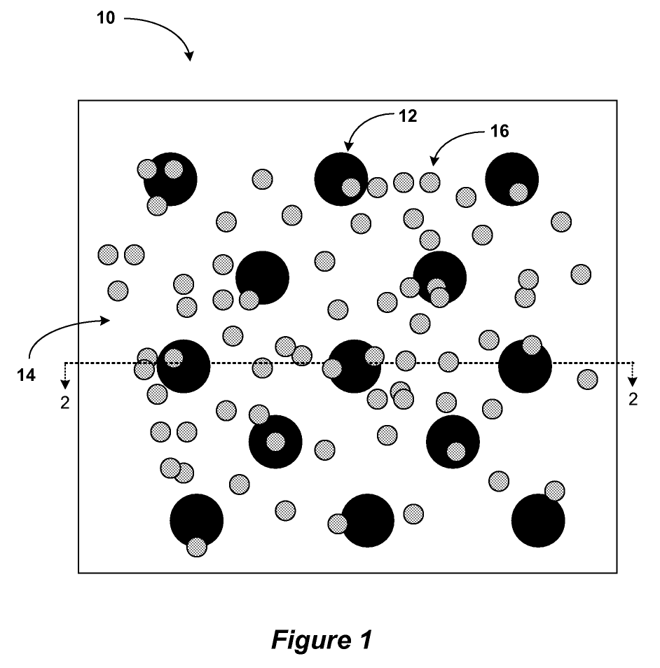

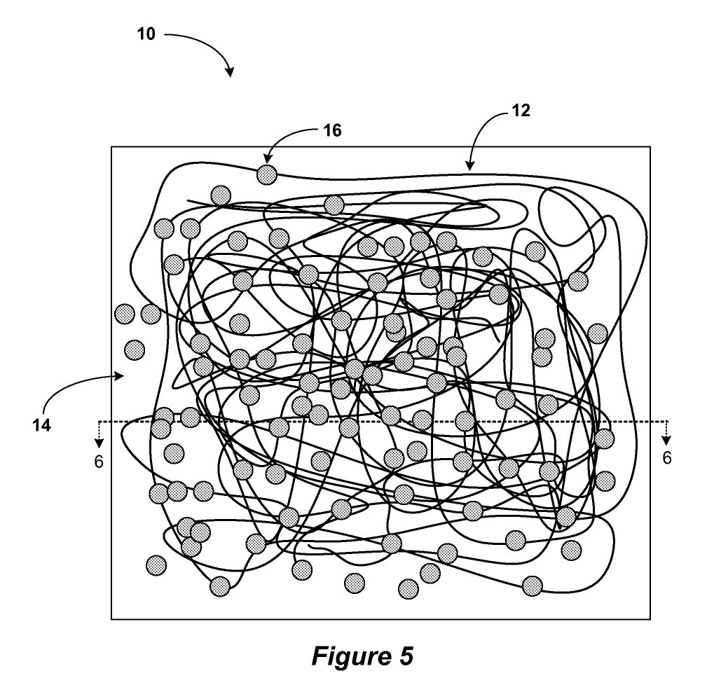

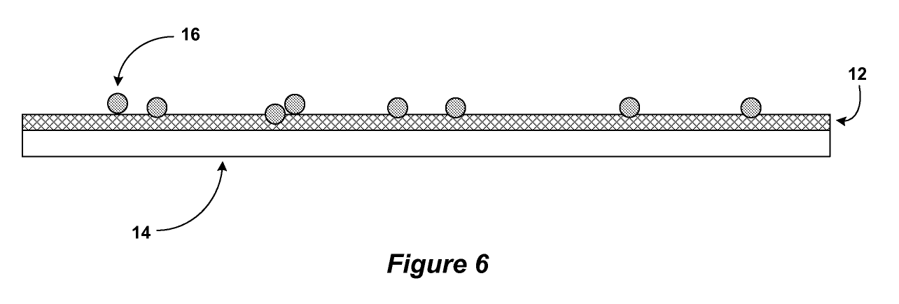

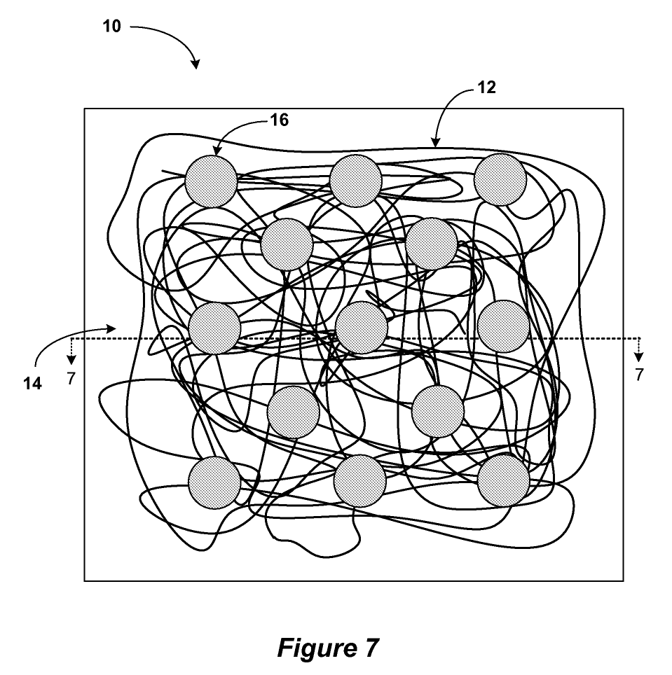

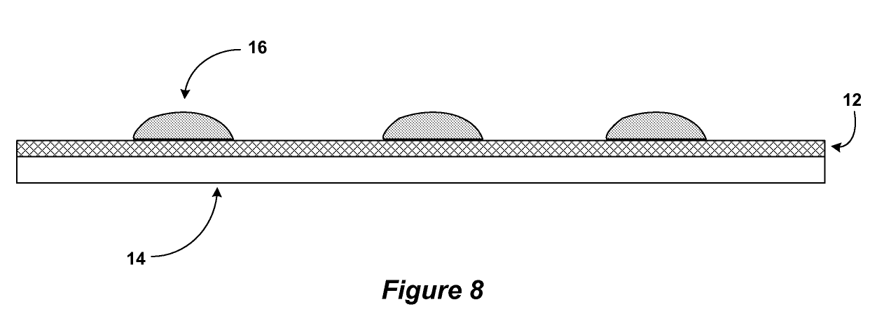

The adhesive components may be applied to the non-woven by a number of techniques. For example, the following are exemplary procedures for applying the adhesives to a given non-woven substrate:
1. Both adhesives may be deposited in specific and defined areas on the nonwoven web through rotary screen or gravure printing techniques by the application of adhesive powder systems. See FIGS. 1-4. Further, the adhesives may be applied by using successive rotary screens, each successive screen applying a different adhesive.
2. An adhesive web may be deposited directly onto a substrate followed by the application of an adhesive powder system using rotary screen techniques See FIGS. 5-6.
3. An adhesive web may be deposited directly onto a substrate combined with an adhesive deposited in specific and defined areas through gravure printing techniques See FIGS. 7-8.

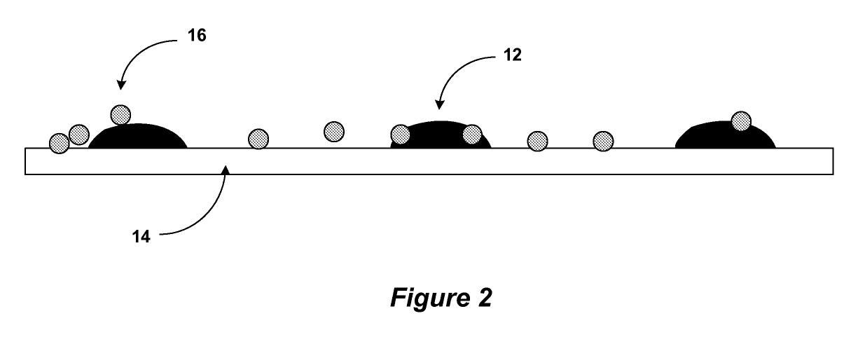

FIG. 1 is a plan view of one exemplary embodiment of the present invention. FIG. 2 is a sectional view of FIG. 1 taken along lines 2-2. The acoustical substrate (10) may include a two component adhesive system. This two component adhesive system comprises a first adhesive component 12 having a first melting point discontinuously applied to discrete and defined areas of the nonwoven web 14, and a second adhesive component 16 applied adjacent to and on the first adhesive component 12.

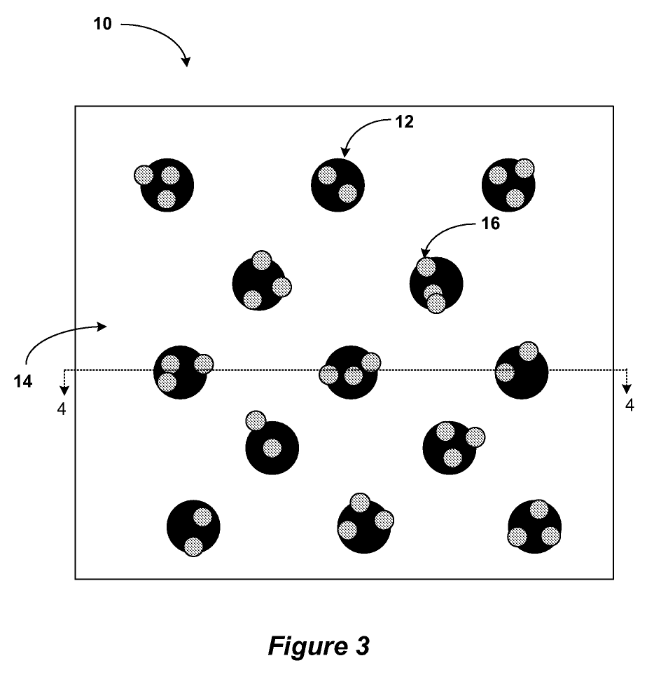

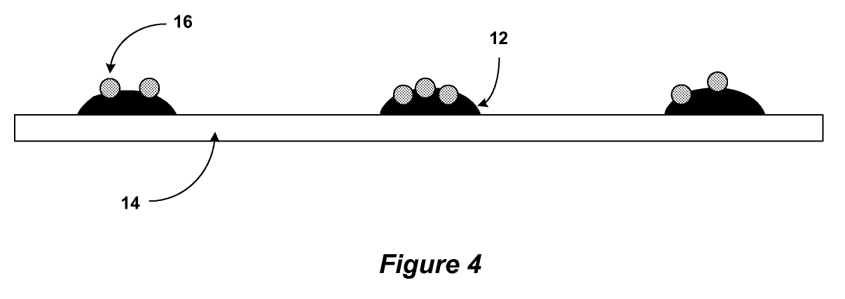

It has been found that it may be advantageous to remove all or a portion of the second adhesive component 16 that may lie directly on the surface of the nonwoven web. FIGS. 3 and 4 illustrate such embodiment in plan and sectional view. In particular, FIGS. 3 and 4 display embodiments that have the second adhesive component 16 removed from the surface of the microfiber nonwoven 14 in between the areas of discrete and specific application of first adhesive component 12. The second adhesive component 16 may be removed by a vacuum or other removal mechanism known to those skilled in the art. FIG. 4 is a sectional view of FIG. 3 taken along lines 4-4.

The adhesive components 12 and 16 in any of the embodiments herein may comprise a thermoplastic with a melting temperature between about 50-275° C. As noted above, one of the components may have a melting point that is at least about 10° C. lower than a second adhesive component. The combination of a relatively low-melt adhesive component and a relatively high-melt adhesive component may then promote sufficient and adequate adhesion of the nonwoven web to a wide range of other fibrous materials, plastics or foam components. In addition, in any of the embodiments herein, the two adhesive components may be applied at a level of greater than about 4 g/m² to about 90 g/m².

In the two component adhesive system illustrated in FIGS. 1-4, the first and second adhesive components 12 and 16 may be applied at a level greater than about 4 g/m². Accordingly, the adhesive components may be applied at about 4 g/m² to 40 g/m² including all values and increments therein. The adhesive components may therefore be applied at a level of about 4 g/m² to 15 g/m². Furthermore, the adhesive components may be applied at a level greater than about 4 g/m². Furthermore, as it relates to the first and second adhesive combinations, they may be present at the same or different concentrations. For example, the ratio of the ratio of the relatively high melting component to low melting component may be in the range of about 1:1 to about 10:1. In addition, the ratio of the relatively low melting component to the relatively high melting component may be in the range of about 1:1 to about 10:1.

With respect to the above referenced adhesive concentrations applied to the surface of the web, it should be appreciated that the concentration and relative proportions of either adhesive component (relatively low or high melting) may be selected depending upon downstream processing requirements. For example, if downstream processing and laminating requirements indicate the need for relatively more high melting adhesive type bonding, the concentration of relatively high melting adhesive may be properly adjusted. Similarly, if downstream processing requirements indicate the need for relatively more low melting adhesive type bonding, the concentration of relatively low melting adhesive may be properly adjusted.

FIGS. 5 and 6 illustrate plan and sectional views, respectively, of another exemplary embodiment of the invention. Again, an acoustical substrate (10) may include a two component adhesive system. This two-component adhesive system may contain a first adhesive 12 that may itself be applied as a continuous web to the nonwoven web 14 and a second adhesive component 16 discontinuously applied to discrete and defined areas on the first adhesive web (i.e. discrete domains). Both the first adhesive web 12 and second adhesive component 16 may be applied adjacent to and encompassing the fibers of the nonwoven web 14. FIG. 6 is a sectional view along line 6-6 of FIG. 5. In addition, it should be appreciated that although FIGS. 5 and 6 illustrate that the first adhesive continuous web 12 may underlie the second adhesive 16, the situation may be reversed as applied to this embodiment and all other embodiments disclosed herein.

FIGS. 7 and 8 illustrate plan and sectional views, respectively, of another exemplary embodiment of the present invention. Again, an acoustical substrate 10 may include a two component adhesive system. This two component adhesive system may comprise a first adhesive web 12 applied to a nonwoven web 14 and a second printed adhesive component 16 applied adjacent to first adhesive web. As noted above, the printed adhesive component may be applied by a gravure printing technique. Both the first adhesive web and second adhesive printed component may be applied adjacent to and encompassing the fibers of the nonwoven web. In addition, as illustrated in FIGS. 7 and 8, the second printed adhesive component 16 may be printed on the first adhesive web. In addition, the situation may again be reversed and the first adhesive component 12 may overlie the second printed adhesive component 16.

Consistent with the above recitation regarding the general characteristics of the adhesives herein, the first adhesive web 12 may employ a thermoplastic adhesive web with a melting temperature between about 100° C. and about 250° C. and the second printed adhesive component 16 may have a melting temperature between about 60° C. and about 180° C., including all values and increments in such ranges. In addition, the first adhesive web may be applied at a basis weight of between about 8 and about 80 grams per square meter to the nonwoven web 14. The first adhesive web may be applied at a basis weight between about 8 g/m² and about 60 g/m². Most preferably the first adhesive web may be applied at a level between about 5 g/m² and about 30 g/m².

To provide an acoustical substrate having water repelling properties, the microfiber nonwoven web including at least a two component adhesive system may be treated with a fluid repellent. For example, the fluid repellant may be a hydrophobic fluid repellant that included relatively non-polar chemical compounds or chemical compounds that rely upon fluorine (F) functionality or even silicon (Si) type functionality. The fluid repellant herein may therefore be applied to the acoustical substrate to reduce or avoid water absorption and/or moisture flow through the substrate. For example, one exemplary fluorochemical compound, which may include fluorine functionality, may include Xcape LVN by Omnova Chemicals and Repearl by Mitsubishi. The fluid repellant herein may be applied at levels up to about 5.0% by weight of the acoustic substrate and may be locally dispersed or dispersed through-out the substrate. Accordingly, the fluid repellant may be present at a level of between about 0.1-5.0% by weight in the non-woven material including the adhesive components, including all values and increments therein.

The following examples are not meant to be limiting, but indicate the typical properties obtained from different exemplary embodiments of the invention.

### EXAMPLE 1

| Property | Value |
|---|---|
| Fabric Weight [grams/m²] ASTM D3776 | 80 |
| Tensile Strength, Machine Direction [lb] | 50 |
| Tensile Strength, Cross Direction [lb] | 50 |
| Thickness [mm] ASTM D1777 | 0.40 |
| Elongation at Break, Machine Direction [%] | 40 |
| Elongation at Break, Cross Direction [%] | 45 |
| Low Melting Adhesive Component Griltex ® | 5 g/m² |
| D1582E | |
| High Melting Adhesive Component Griltex ® 6E, | 5 g/m² |
| Bond Strength* (N/2″) | 5.5 |

*Bond strength is measured as the force required to delaminate the acoustic substrate from a polyester/wool fabric. The fabric was bonded to the acoustic substrate at 255° F. for 11 seconds. The test was conducted in accordance with ASTM D2724-03 Standard Test Methods for Bonded, Fused, and Laminated Apparel Fabrics.

### EXAMPLE 2

| Property | Value |
|---|---|
| Fabric Weight [grams/m²] ASTM D3776 | 100 |
| Tensile Strength, Machine Direction [lb] | 60 |
| Tensile Strength, Cross Direction [lb] | 60 |
| Thickness [mm] ASTM D1777 | 0.48 |
| Elongation at Break, Machine Direction [%] | 40 |
| Elongation at Break, Cross Direction [%] | 45 |
| Low Melting Adhesive Component Griltex ® | 5 g/m² |
| D1582E | |
| High Melting Adhesive Component Griltex ® 6E, | 5 g/m² |
| Bond Strength* (N/2″) | 5.5 |

The foregoing description is provided to illustrate and explain the present invention. However, the description hereinabove should not be considered to limit the scope of the invention set forth in the claims appended hereto.

What is claimed is:

1. An acoustical substrate, comprising;
a nonwoven web, and
a first adhesive having a first melting temperature (Tm₁) and a second adhesive having a second melting temperature (Tm₂) wherein Tm₁ is not equal to Tm₂; and
a fluid repellant dispersed in said non-woven web.

2. The acoustical substrate of claim 1 wherein Tm₁ and Tm₂ have a difference in melting temperature of at least about 10° C.

3. The acoustical substrate of claim 1 wherein the first and second adhesive comprise a thermoplastic polymer with a melting temperature of about 50° C. to about 275° C.

4. The acoustical substrate of claim 1, wherein said nonwoven material comprises fibers with a diameter of less than 100 μm.

5. The acoustical substrate of claim 1 wherein said nonwoven material comprises fibers having a basis weight of less than about 400 grams per square meter.

6. The acoustical substrate of claim 1 wherein said non-woven material has an acoustical impedance of about 200-2000 Rayls (MKS).

7. The acoustical substrate of claim 1, wherein said nonwoven material comprises a spunbond material.

8. The acoustical substrate of claim 1 wherein said nonwoven material comprises a melt blown material.

9. The acoustical substrate of claim 1 wherein said nonwoven material comprise a composite of a spunbond material and a meltblown material.

10. The acoustical substrate of claim 1 wherein said first or second adhesive component is in the form of a plurality of discrete non-continuous domains on or within the nonwoven web.

11. The acoustical substrate of claim 1, wherein said first or second adhesive component is in the form of a continuous web on or within the non-woven web.

12. The acoustical substrate of claim 1 wherein one of said adhesive components is in a discrete non-continuous form and one of said adhesive components is in the form of a continuous web.

13. The acoustical substrate of claim 1 wherein either of said first or second adhesive component is present at a level of greater than about 4 grams per square meter.

14. The acoustical substrate of claim 1 wherein said fluid repellant comprise a fluorochemical compound.

15. The acoustical substrate of claim 1 wherein said fluid repellant comprises a compound containing silicon functionality.

16. The acoustical substrate of claim 1 wherein said fluid repellant is present at a concentration of about 0.1 to about 5.0% by weight.

17. The acoustical substrate of claim 1 including a third adhesive having a melting point (Tm₃) wherein Tm₃ is not equal to Tm₁ or Tm₂.

18. A process for forming an acoustical substrate comprising:
providing a first nonwoven web;
applying a first adhesive having a first melting temperature (Tm₁) and a second adhesive having a second melting temperature (Tm₂) wherein Tm₁ is less than Tm₂;
providing a first sound attenuating component and laminating at a temperature above Tm₁ while maintaining said laminating temperature at a temperature below Tm₂; and
providing a second sound attenuating component and laminating at a temperature above Tm₂.

19. The process of claim 17 wherein said first nonwoven material comprises fibers with a diameter of less than 100 μm.

20. The process of claim 17 wherein the first and second adhesive comprise a thermoplastic polymer with a melting temperature of about 50° C. to about 275° C.

21. The process of claim 17 wherein said nonwoven material comprises fibers having a basis weight of less than about 400 grams per square meter.

22. The process of claim 17 wherein said first or second adhesive component is applied as discrete non-continuous domains.

23. The process of claim 17 wherein said first or second adhesive component is applied in the form of a continuous web.

24. The process of claim 17 wherein one of said adhesive components is in a discrete non-continuous form and one of said adhesive components is in the form of a continuous web.

25. The process of claim 17 including dispersing a fluid repellant in said non-woven web.
